(19) United States
(12) Patent Application Publication
(10) Pub. No.: US 2025/0166018 A1
(43) Pub. Date: May 22, 2025

(54) Use of Non-Streaming-Pattern Data Flow as Basis to Trigger Monitoring for Ad Exposure

(71) Applicant: The Nielsen Company (US), LLC, New York, NY (US)

(72) Inventors: Stanley Wellington Woodruff, III, Palm Harbor, FL (US); John Thomas LiVoti, Clearwater, FL (US)

(21) Appl. No.: 18/510,965

(22) Filed: Nov. 16, 2023

(51) Int. Cl. G06Q 30/0272; H04L 43/0894

(52) U.S. Cl. CPC G06Q 30/0272; H04L 43/0894

(57) ABSTRACT

A method and system for controlling advertisement-exposure monitoring. An example method includes (i) a computing system receiving digital query signature data representing media presented at a given time at a panelist site, (ii) the computing system determining, based on network-monitoring at the panelist site, that, at the given time, the panelist site was receiving a non-zero packet-data flow that had a bit rate too low to be program-content streaming, and (iii) responsive to at least the determining, the computing system searching through advertisement reference signature data for a match, between the advertisement reference signature data and the digital query signature data, that would establish that the media presented at the given time was a given advertisement.

### SUMMARY

In order to measure the extent to which people of various demographics are exposed to media content presented by media-presentation devices such as televisions, computers, tablets, phones, gaming devices, smart speakers, or other devices, a media-monitoring company can arrange to have media-monitoring devices or “presentation meters” monitor media presentation in representative households or other sites. People who have their media exposure monitored may be considered “panelists,” and the places where the monitoring occurs, such as home, offices, or other premises, may be considered “panelist sites.”

At each of various panelist sites having a media-presentation device for instance, the media-monitoring company may arrange for a presentation meter to monitor media presentation by that device and to generate query signature data representing the presented media. Further, the media-monitoring company may also operate a computing system, such as a cloud-based computing system, to receive and evaluate this presentation-meter-generated query signature data, in order to identify the media presented at the panelist site and thereby to establish associated media-exposure data.

For instance, by evaluating an audio line feed into the media-presentation device and/or by evaluating associated acoustic speaker output, a representative presentation meter at a panelist site may be configured to detect and extract watermarked identification codes from the audio and/or to generate digital audio fingerprint data representing the audio, and to report the identification codes and/or fingerprint data, along with associated timestamps, as query signature data to the computing system for analysis. Such a presentation meter may also be configured to detect the power on or off state of the media-presentation device, so that the presentation meter can limit its media-presentation monitoring to times when the media-presentation device is on and therefore likely presenting media content being delivered to the media-presentation device.

The computing system may then be configured to refer to reference signature data that maps various identification codes and/or fingerprint data to known media content items, in order to determine, based on the presentation-meter-reported identification codes and/or fingerprint data, what media content the media-presentation device was presenting at the indicated time. In particular, the computing system may be configured to search through the reference signature data in an effort to find reference signature data that matches the reported query signature data and, upon finding a match with sufficient certainty, to conclude that media represented by the query signature data is the media associated with the matching reference signature data, and to establish associated media-presentation records for the panelist site.

Further, the computing system may be configured to correlate these media-presentation records with pre-stored demographics of the panelist or panelist site at issue, in order to establish associated media-exposure data, and the computing system may be configured to use this media-exposure data from multiple panelist sites as a basis to establish ratings statistics that may facilitate commercial processes such as ad placement and other content delivery.

In an example implementation, to facilitate this process, the computing system could maintain or otherwise have access to a set of reference signature data specifically for identifying linear broadcast content feeds such as television-channel broadcasts, for instance, and possibly for identifying specific programs broadcast on such channels. This reference signature data, which may be referred to as Linear Media Monitoring Service (LMMS) reference signature data, could be established by implementing monitoring receivers tuned to known channels and configured to extract from the known channels watermarked codes as reference codes keyed to those known channels or their associated content, and/or to generate digital fingerprint data as reference fingerprint data representing and thus keyed to the media content on those known channels, among other possibilities. By matching the presentation-meter-provided query signature data against this LMMS reference signature data, the computing system may thus identify linear broadcast channels and possibly associated content presented at the panelist site.

In addition, the computing system may also maintain or otherwise have access to a separate set of reference signature data for non-linear streaming-media content (e.g., movies, television shows, podcasts, etc.) that panelists could watch, listen to, or otherwise consume on demand, e.g., from over-the-top (OTT) streaming-media providers or the like. This reference signature data, which may be referred to as Streaming Media Monitoring Service (SMMS) reference signature data, could be established by evaluating known streaming-media content items, possibly from particular OTT channels, extracting from the known streaming-media content items watermarked codes as reference codes keyed to those known streaming-media content items and/or generating digital fingerprint data as reference fingerprint data representing and thus keyed to the known streaming-media content items, among other possibilities. By matching the presentation-meter-provided query signature data against this SMMS reference signature data, the computing system may thus also identify non-linear media content, such as streaming-media content, presented at the panelist site.

In practice, the computing system may conduct this matching process with respect to query signature data that the computing receives from the presentation meter over time or that otherwise represents media content presented at the panelist site over time. That way, the computing system could establish records that indicate, per unit time, what media content was presented at the panelist site. For instance, the computing system may establish these records on a per minute basis or even a per-sub-minute basis, among other possibilities. Further, the computing system may conduct this analysis in real-time (e.g., as the computing system receives the query signature data from the panelist site, possibly soon after the associated media presentation occurred) and/or through post-processing (e.g., at the end of each day), among other possibilities.

As to each of various time segments of this presentation-meter-provided query signature data representing a corresponding time segment of media presentation at the panelist site, the computing system may further conduct its analysis as a multi-step process that helps make the computing system's use of the reference signature data relatively efficient. In particular, this multi-step process may help to control when the computing system will try to match the query signature data against the SMMS reference signature data.

In an example of this two-step process, as to each time segment of presentation-meter-provided query signature data, the computing system may initially restrict its matching analysis to just the LMMS reference signature data, in an effort to identify the presented media content as particular known linear broadcast content. The computing system may then turn to conduct matching with respect to the SMMS reference signature data just if and when the computing system finds no match with respect to the LMMS reference signature data.

In particular, for each time segment of presentation-meter-provided query signature data, the computing system may first search the LMMS reference signature data in an effort to find a match. Based on this search of the LMMS reference signature data, if the computing system thereby finds with sufficient certainty that the query signature data for that time segment matches LMMS reference signature data representing known linear broadcast content, then the computing system may responsively establish a record indicating that, at that time, that the panelist site was presenting that known linear broadcast content. Whereas, if the computing system does not find with sufficient certainty that the query signature data for that time segment matches any LMMS reference signature data, then, based at least on this absence of matching with the LMMS reference signature data, the computing system may responsively proceed to search the SMMS reference signature data in an effort to find a match.

If the computing system thus proceeds to search the SMMS reference signature data for a match, and if the computing system thereby finds with sufficient certainty that the query signature data for the time segment matches SMMS reference signature data representing known streaming-media content, then the computing system may responsively establish a record indicating that, at that time, that the panelist site was presenting that known streaming-media content. Whereas, if the computing system thereby does not find with sufficient certainty that the query signature data for that time segment matches any SMMS reference signature data, then, based at least on that absence of matching with the SMMS reference signature data, along with the absence of matching with the LMMS reference signature data, the computing system may establish an “inconclusive” record for that time segment (e.g., a record specifying an inconclusive result such as “All Other Tuning” (AOT) or “All Other Code” (AOC)), meaning that the computing system did not identify the media content that was being presented by the panelist site at that time.

To help manage this process further, the computing system may also take into consideration whether and when the panelist site was receiving a packet-data flow having a pattern or form that is deemed to be consistent with streaming media, i.e. having a “pattern of streaming.” Namely, when the computing system determines that presentation-meter-reported query signature data for a given time at the panelist site does not match any LMMS reference signature data, the computing system may further determine whether, at that time, the panelist site was receiving a packet-data flow that has a pattern of streaming, and the computing system may use this further determination as a basis to control whether the computing system will proceed to search the SMMS reference signature data for a match.

For instance, if the computing system thereby determines that, at that time, the panelist site was not receiving a packet-data flow that had a pattern of streaming, then the computing system may forgo searching for a match of the query signature data in the SMMS reference signature data, since a reasonable conclusion in that situation may be that the panelist site was not receiving and presenting streaming media at that time. In that case, since the computing system did not find a match of the query signature data in the LMMS reference signature data and since the computing system concluded that the panelist site was not presenting streaming media at the time, the computing system may record an “inconclusive” result as noted above. Whereas, if the computing system thereby determines that, at that time, the panelist site was receiving a packet-data flow that had a pattern of streaming, then the computing system may proceed to search the SMMS reference signature data for a match, in an effort to identify streaming media content that was being presented at the panelist site at the time.

To facilitate this consideration of the packet-data flow at the panelist site as a basis to control the computing system's use of the SMMS reference signature data, the media-measurement company may additionally equip the panelist site with another type of meter, namely, a streaming meter, that is configured to monitor packet-data flow on a local area network (LAN) at the panelist site and to report to the computing system information about that packet-data flow. In practice, this streaming meter and the presentation meter could be separate devices or could be integrated together.

This streaming meter may be configured to detect and report to the computing system various streaming events on the LAN, such as (i) when the LAN is receiving a packet-data flow that has a high enough bit rate and/or one or more other characteristics deemed to be a pattern of streaming, and (ii) when transitions occur between the LAN receiving a packet-data flow deemed to have a pattern of streaming and the LAN receiving no packet-data flow or receiving packet-data flow that has a low bit rate and/or one or more other characteristics deemed to not be a pattern of streaming.

Based on these reports from the streaming meter at the panelist site, the computing system may thus be able to determine times when the panelist site was receiving a packet-data flow that had a pattern of streaming and times when the panelist site was receiving no packet-data flow or was receiving a packet-data flow that did not have a pattern of streaming. The computing system may then use this information as a basis to control whether, for time segments as to which the computing system find that the presentation-meter-reported query signature data does not match the LMMS reference signature data, the computing system will turn to search for a match with the SMMS reference signature data, as noted above.

Unfortunately, one technical issue with this process is that some streaming media that is received by and presented at a panelist site may not be of a form that is deemed to be typical of streaming media, i.e., may not be deemed to have a pattern of streaming, but it may still be commercially worthwhile to monitor panelist exposure to that streaming media. An example of such streaming media is streaming advertisements that may be inserted interstitially within streaming program content.

In particular, the streaming meter and/or computing system's baseline analysis to determine if packet-data flow has a “pattern of streaming”, e.g., as a basis to justify searching for a match in the SMMS reference signature data, may be keyed to one or more characteristics of streaming program content such as television shows and movies for instance. That is, the “pattern of streaming” that the computing system may look for as a basis to trigger searching for a match in the SMMS reference signature data may be a pattern of program-content streaming. But in addition to receiving and presenting streaming program content such as television shows and movies, the panelist site may also receive and present streaming advertisements (e.g., commercial breaks), which may not have a high enough bit rate and/or one or more other characteristics typical of streaming program content and that the streaming meter and/or computing system may therefore not find to be a basis for searching for a match in the SMMS reference signature data.

For example, the streaming meter and/or computing system may be set to monitor data flow (e.g., on a per-domain basis, such as on a per source-IP-address basis) in short periods (e.g., 3, 5, 10, or 12 second periods) and to detect the presence of a pattern of streaming at times when (i) there is at least a predefined threshold number (e.g., 5, 6, 7, or 8) such periods of data contiguously from the same domain as each other, (ii) at least one of the threshold number of periods has at least a threshold high peak data rate (e.g., 30 kilobytes per second, 50 kilobytes per second, 100 kilobytes per second, or 1,000 kilobytes per second), and (iii) the minimum average data rate over the course of the detected periods is at least a predefined threshold high data rate (e.g., at least 10 kilobytes per second, at least 30 kilobytes per second, at least 100 kilobytes per second, or at least 1,000 kilobytes per second). This or other example processes may thus involve detecting a data flow with a bit rate that may be considered high enough to be typical of streaming of program content such as movies and television shows from OTT providers or the like. Therefore, as to query signature data representing media presented at the panelist site at times when the streaming meter was detecting such a pattern of packet-data flow, the computing system may reasonably turn to search the SMMS reference signature data in an effort to find a match.

However, the panelist site may also receive advertisements as streaming media with a lower bit rate than is typical of streaming program content. For instance, as the panelist site is receiving and presenting OTT-provided streaming program content such as a television show or movie with a packet-data flow having a pattern of streaming like that noted above, that program content may have commercial breaks during which the panelist site may receive one or more streaming advertisements having a lower bit rate (e.g., with corresponding lower resolution). Advertisements may be lower bit rate than program content for various reasons, including possibly to facilitate quick and/or dynamic insertion of the advertisements if applicable, among other possibilities.

With the process described above, given query signature data representing a time segment of such a streaming advertisement presented at the panelist site, the computing system may find that the query signature data does not match the LMMS reference signature data and may also find, based on reporting from the streaming meter, that, at that time, the panelist site was not receiving a packet-data flow having a pattern of streaming. Therefore, as discussed above, the computing system may unfortunately record an inconclusive result for that time segment.

The present disclosure provides an improved technical mechanism that may help to improve media-exposure monitoring.

In accordance with the disclosure, when the computing system finds that query signature data for a particular time segment of media presentation at the panelist site does not match the LMMS reference signature data and that, at that time, the panelist site was receiving a packet-data flow that did not have a pattern of program-content streaming (e.g., a high enough bit rate and/or one or more other characteristics deemed to be consistent with program-content streaming), the computing system will make good use of that situation by responsively performing advertisement-matching. Namely, the computing system may respond to that situation by then seeking to determine if the query signature data for that time segment matches reference signature data representing an advertisement, in an effort to determine that the media being presented by the media-presentation device at that time was a particular advertisement.

Further, a variation of this process may omit consideration of LMMS reference data altogether. For instance, if the computing system receives query signature data representing media content presented at a particular time at a panelist site, and the computing system further determines based on monitoring of packet-data flow at the panelist site that, at that time, the panelist site was receiving a packet-data flow that did not have a pattern of program-content streaming, the computing system may respond to at least that determination by proceeding to search for a match of the query signature data in reference signature data representing advertisements, in an effort to determine that the media being presented by the media-presentation device at that time was a particular advertisement.

To facilitate this process, the computing system may further maintain or otherwise have access to a set of reference signature data representing advertisements, perhaps specifically advertisements that are known to be candidates to be streamed. This advertisement reference data, which may be referred to as Advertisement Media Monitoring Service (AMMS) reference signature data, could be established by evaluating known advertisements that are candidates to be streamed (e.g., to be dynamically injected into streaming program content) or otherwise provided to panelist sites, extracting watermarked codes as reference codes keyed to those known advertisements and/or generating digital fingerprint data as reference fingerprint data representing and thus keyed to those known advertisements, among other possibilities.

By matching the presentation-meter-provided query signature data against this AMMS reference signature data, the computing system may thus identify streaming advertisements presented at the panelist site, which may usefully facilitate establishing advertisement-ratings data and the like, and may in turn inform other useful decisions and processes, such as controlling future ad placement and pricing, among other possibilities.

Further, by searching the AMMS reference signature data for a match as to a time when the packet-data flow at the panelist site did not have a pattern of program-content streaming, the computing system may usefully reduce the extent to which the computing system reaches an inconclusive result such as an AOT or AOC result. For instance, even for times of media presentation as to which the query signature data does not match the LMMS reference data and the packet-data flow does not have a pattern of streaming, the computing system may still find that the query signature data matches the AMMS reference signature data for a known advertisement, and the computing system may therefore usefully establish a record of presentation of that advertisement at the panelist site, rather than recording an inconclusive result.

In accordance with the present disclosure, the computing system's decision to search the AMMS data in an effort to find that the query signature data matches reference signature data representing a known advertisement could further be based on one or more other factors that may help support a conclusion that the panelist site was receiving a streaming advertisement at the time. Without limitation, examples of these other factors may include (i) finding that the panelist site (e.g., a user of the panelist site) subscribes to an advertisement-based streaming-media service, (ii) finding that there was a threshold high rate of back-and forth messaging, such as request and response messaging, between the panelist site and an external network address at the time, which may be typical of a streaming media session, and/or (iii) detecting one or more transitions of packet-data flow to the panelist site that may be typical when transitioning between receiving streaming program content and receiving streaming advertisement content.

These as well as other aspects, advantages, and alternatives, will become apparent to those of ordinary skill in the art by reading the following detailed description, with reference where appropriate to the accompanying drawings. Further, it should be understood that the disclosure provided in this summary elsewhere in this document is provided by way of example only and that numerous variations and other examples may be possible as well.

### BRIEF DESCRIPTION OF THE DRAWINGS

FIG. 1 is a simplified block diagram illustrating an example system in which disclosed features can be implemented.

FIG. 2 is an illustration of transitions in packet-data flow that may support an inference of advertisement streaming.

FIG. 3 is a flow chart illustrating an example method.

FIG. 4 is a simplified block diagram of an example computing system.

FIG. 5 is a simplified block diagram of an example presentation meter.

FIG. 6 is a simplified block diagram of an example streaming meter,

### DETAILED DESCRIPTION

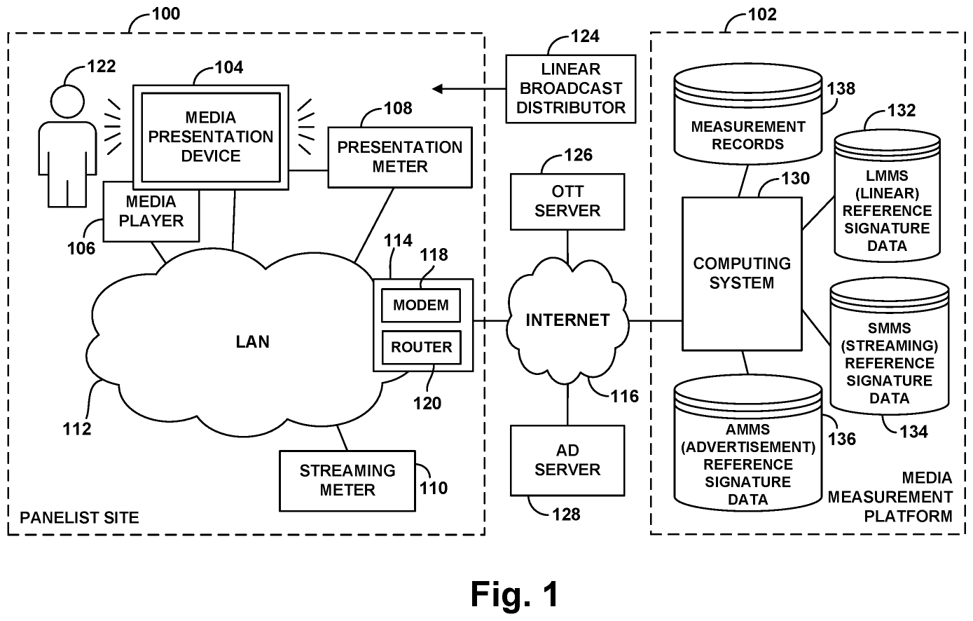

Referring to the drawings, as noted above, FIG. 1 is a simplified block diagram of an example system in which various disclosure features can be implemented. It should be understood, however, that this and other arrangements and processes described herein could take various other forms. For instance, elements and operations could be re-ordered, distributed, replicated, combined, omitted, added, or otherwise modified. In addition, elements described as functional entities could be implemented as discrete or distributed components or in conjunction with other components/modules, and in any suitable combination and location. Further, various operations described as being carried out by one or more entities could be implemented by and/or on behalf of those entities, through hardware, firmware, and/or software, such as by one or more processing units executing program instructions stored in memory, among other possibilities.

As shown in FIG. 1, the example system includes a panelist site 100 and a media-measurement platform 102.

The panelist site 100 may be a panelist's home or office, among other possibilities and, in the example arrangement, includes a media-presentation device 104, a media player 106, a presentation meter 108, and a streaming meter 110. Further, the panelist site 100 includes a LAN 112, with the media-presentation device 104, media player 106, presentation meter 108, and streaming meter 110 sitting as example nodes on the LAN 112. In addition, the panelist site 100 includes network equipment 114 that facilitates communication on the LAN 112 and communication between the LAN 112 and the internet 116 or another wide area network.

As shown, the network equipment 114 in the example arrangement may include a modem 118 and a router 120. The modem 118, which may be a cable, satellite, cellular, or other modem, may be configured to communicate with an associated internet service provider (ISP) (e.g., cable or satellite head end, or cellular core network) (not shown) that provides connectivity with the internet 116. And the router 120, which may itself also sit as a node on the LAN 112, may be configured to route packet-based communications between nodes on the LAN 112 and, via the modem, between the LAN 112 and the internet 116.

The modem 118 may have an assigned Internet Protocol (IP) address that is globally-routable on the internet 116 (i.e., a global IP address). For instance, when the modem 118 is initially powered on, the modem 118 may register its presence with the ISP, and the ISP may dynamically assign a global IP address to the modem 118, or the modem 118 may have a statically assigned global IP address. This global IP address assigned to the modem 118 may also pass through to the router 120 as an effective global IP address of the router 120.

Each LAN node may also have an assigned IP address that is locally-routable on the LAN 112 (i.e., a local IP address). For instance, the router 120 may have a statically assigned local IP address. Further, as each other node is initially powered on and in communication with the router 120, the node may register its presence with the router 120, and the router 120 may dynamically assign a local IP address to the node, or the node may a statically assigned local IP address. With these assigned local IP addresses, the LAN nodes may then engage in packet-based communication on the LAN 112. Further, the LAN nodes may engage in packet-based communications on the internet 116, through the router 120 and the modem 118, with the router 120 performing network address translation between the device's local IP address and the router/modem's global IP address.

In addition, each LAN node may have a permanent or semi-permanent hardware address, typically a Media Access Control (MAC) address assigned to a network interface of the node during manufacturing. This MAC address may uniquely identify the node. For instance, a node's MAC address may include a prefix or one or more other components keyed to the node's manufacturer and thus possibly indicating a brand of the node, and a node's MAC address might also include one more components corresponding with the node's model or other such information.

The media-presentation device 104 at the panelist site 100 may take any of the forms noted above among other possibilities, and may be configured to present media content, which may include video content and audio content and may include program content (e.g., television programs, videos, podcasts, radio shows, and movies) and advertisement content (e.g., commercial breaks). The media-presentation device 104 be a single unit or a multi-component system such as one component that presents video and another component that outputs corresponding audio for instance. As further shown, an example panelist (e.g., a human being) 122 at the panelist site 100 may be exposed to this media presentation.

The media-presentation device 104 may be configured to receive and present media content from one or more media sources, examples of which include a linear broadcast source and a streaming-media source, among other possibilities.

A linear broadcast source may include a linear broadcast distributor 124, such as a satellite TV head end, cable TV head end, a satellite radio head end, or an over-the-air (OTA) terrestrial broadcaster, among other possibilities. This linear broadcast distributor 124 may be a multi-channel video or audio program distributor, providing multiple channels of linear broadcast content for selective playout at the panelist site 100. The panelist site 100 may then further be equipped with a set top box or other device (possibly media player 106) configured to allow user selection of a given such linear broadcast channel to be presented by the media-presentation device 104, to tune the selected channel, and to provide the channel as a linear broadcast feed to the media-presentation device 104, and the media-presentation device 104 may thus present that selected linear broadcast channel.

A streaming-media source, on the other hand, may include an OTT server 126, among other possibilities. The OTT server 126 may be configured to provide streaming media content on demand in a streaming media session to the panelist site 100. To facilitate this, the media player 106 at the panelist site 100 (which may be separate from or integrated with the media-presentation device 104) may be configured to interwork with the OTT server 126. For instance, the OTT server 126 may be accessible at a particular IP address on the internet 116, and the media player 106 may engage in signaling with the OTT server 126 at that address to request the OTT server 126 to stream user-selected media content on demand to the media player 106. In real time as the OTT server 126 then streams the selected media content in response to the media player 106, the media player 106 may receive that streaming media session and output the media content for presentation by the media-presentation device 104.

Without limitation, streaming sessions like this could operate according to any of a variety of well-known adaptive bit-rate streaming protocols, examples of which include Dynamic Adaptive Streaming over Hypertext Transfer Protocol (HTTP) (DASH), HTTP Live Streaming (HLS), and Smooth Streaming Transport Protocol (SSTP).

Under such a protocol, the media player 106 may first request and obtain from an OTT server 126 a manifest that lists media stream segments and bit-rate versions available per segment. The media player 106 may then proceed to request and obtain desired bit-rate versions of those segments in sequence, varying the bit rate over time as necessary to help account for changes in operational conditions. And as the media player 106 receives the segments, the media player 106 may buffer the segments and ultimately transcode them into a form suitable for output to and presentation by the media-presentation device 104, thus facilitating largely real-time presentation of the selected media stream as the media player 106 receives the media stream.

These communications by the media player 106 may all be packet-based. For instance, to obtain a manifest for the selected stream, the streaming-media player 104 may transmit to the OTT server 126 one or more IP packets carrying a request for the manifest and may receive in response from the OTT server 126 one or more IP packets carrying the requested manifest. Likewise, to obtain the sequential segments of the media stream for playout, the media player 106 may transmit to the OTT server 126 a number of IP packets carrying requests for the segments and may receive in response from the OTT server 126 packets that carry the requested segments.

Further, these packet-based communications may be keyed to the local IP address and/or MAC address of the media player 106, with network address translation (NAT) between that local IP address and the global IP address of the router/modem.

For instance, when the media player 106 sends a packet destined to the IP address of an OTT server 126, the media player 106 may designate in a header of that packet that the source IP address of the packet is the media player's local IP address, and that the destination IP address of the packet is the OTT server's global IP address. As that packet passes through the router 120, the router 120 may apply NAT, translating the designated local IP source address to the router's global IP address, and ensuring that there is a record or designation of a port or MAC address associated with the designated local IP source address so that the router 120 can properly route a response.

When the OTT server 126 then sends a packet back in response, that response packet would designate that the source IP address of the packet is the OTT server's global IP address and that the destination IP address of the packet is the router's global IP address. Therefore, the packet will be routed ultimately to the router 120. Based on the record or designation of the port or MAC address associated with the local IP address from which the request originated, the router 120 may then translate the designated global IP destination address to the media player's local IP address. And the router 120 may then route the packet accordingly over the LAN to that local IP address, to facilitate receipt by the media player 106.

As the OTT server 126 streams program content such as a television show or movie to the media player 106, there may be commercial breaks in that streaming media content. For instance, certain free or subscription-based OTT services may be ad-supported, in which case the OTT server 126 may arrange for insertion of advertisements from time to time into the streaming media session that the OTT server 126 is providing to the media player 106, to help cover the cost of providing the OTT service.

In particular, at certain times during streaming of the program content to the media player 106, the OTT server 126 may coordinate a transition from the program content to a commercial break including one or more advertisements and then a transition from the commercial break back to the program content. Thus, the streaming media that the media player 106 receives and that the media presentation player 104 presents would accordingly transition from the streaming program content to one or more streaming advertisements and then back to the streaming program content.

The OTT server 126 may insert these advertisements into the streaming media session itself or may interwork with a separate ad server 128 to have the ad server 128 insert these advertisements into the streaming media session. In either case, for instance, the OTT server 126 may structure the above-noted manifest or other process accordingly so that media player 106 would transition over time from (i) receiving and providing for presentation by the media-presentation device 104 the streaming program content to (ii) receiving and providing for presentation by the media-presentation device 104 the streaming advertisement content, and then back to (iii) receiving and providing for presentation by the media-presentation device 104 the streaming program content or other streaming program content.

As noted above, advertisements may be streamed at a lower bit rate than program content such as television shows or movies. For example, as noted above, program content may be streamed to the media player 106 at a bit rate on the order of at least 30 to 1,000 kilobytes per second (i.e., at least 240 to 8,000 kilobits per second). Whereas, advertisements may be streamed at a bit rate substantially lower than that and/or otherwise not rising to the level of the “pattern of streaming” described above (e.g., not meeting one or more of the “pattern of streaming” criteria noted above).

This may be a result of the advertisements being lower resolution and/or may help to facilitate seamless transition by the media player 106 between program content and advertisement content, among other possibilities.

In addition, there may be other points of distinction between streaming of program content and streaming of advertisement content.

By way of example, the program content and advertisement content may be streamed from different source IP addresses than each other. For instance, the OTT server 126 may arrange for the ad server 128 to stream advertisements in a commercial break to the media player 106, so the media player 106 may request and receive those advertisements from an IP address of the ad server rather than from an IP address of the OTT server 126. As a result, packets carrying the advertisements to the media player 106 may thus have a different source IP address than the packets carrying the program content from the OTT serer 126 to the media player 106.

As another example, the program content and advertisement content may have different associated metadata than each other. This metadata may include data indicating of the owner and/or associated digital rights management (DRM) information, which may relate to the provider and/or digital-rights holder of the respective content, among other possibilities. In some implementations, packets carrying streaming media content to the media player 106 may specify this metadata, for instance in header fields or other fields.

Continuing with reference to FIG. 1, the presentation meter 108 and streaming meter 110 at the panelist site 100 may operate as discussed above to log media presentation and streaming-media activity respectively and to report that logged data to a computing system 130 of the media-measurement platform 102, for use in generating audience ratings or for other purposes. In particular, the presentation meter 108 may operate to monitor media presentation by the media-presentation device 102, and the streaming meter 110 may operate to monitor for streaming-media activity on the LAN 112.

Though these meters are shown as separate devices, they could alternatively be integrated together as an integrated device that has a view into both media presentation and LAN activity. Further, the meters could interoperate with each other, such as by sharing their logged data with each other and possibly having just one of the meters assume responsibility for reporting both meters' logged data, among other possibilities.

In line with the discussion above, the presentation meter 108 may be configured to monitor both the on/off state of the media presentation device 104 and media presentation by the media-presentation device 104. To facilitate monitoring the on/off state of the television media-presentation device 104, the presentation meter 108 could be connected as an intermediary in a path of power-supply to the media-presentation device 104 if applicable. The presentation meter 108 could then monitor current flow and/or other electronic characteristics on that path, to determine when the media-presentation device 104 is powered on and when the media-presentation device 104 is powered off. The presentation meter 108 could then limit its monitoring of media presentation by the media-presentation device 104 to times when media-presentation device 104 is powered on.

Further, the presentation meter 108 could be configured to monitor media presentation by the media-presentation device in various ways. For instance, the presentation meter 108 could be connected as an intermediary in the media-delivery path between a receiver device (e.g., set top box, streaming-media player, etc.) and the media-presentation device 104, if applicable. The presentation meter 108 could then monitor media flowing on that path. Alternatively, the presentation meter 108 could include one or more microphones and/or cameras configured to receive audio and/or video output presented by the media-presentation device 104 and/or associated systems and could monitor that received audio and/or video.

The presentation meter 108 may interwork with the computing system 130 of the media-measurement platform 102 (one or more associated servers) to detect and evaluate media presentation by the media-presentation device 104 (and/or by an associated system), which may include identifying the media presented by the media-presentation device 104, to facilitate generating audience ratings statistics and/or for other purposes. By way of example, the presentation meter 108 may detect the presence of media output by the media-presentation device 104 and may obtain media-signature data such as digital fingerprints and/or watermark encoded information from the media and transmit the obtained media-signature data as query signature data to the computing system 130 for evaluation as discussed above.

As to digital fingerprints, for instance, as the media presentation proceeds, the presentation meter 108 may evaluate the media being presented and, based on the evaluation, may generate digital query fingerprints each representing component characteristics of the media, such as key audio-frequency characteristics and/or key video-pixel characteristics. Further, the presentation meter 108 may include with each query fingerprint a timestamp indicating time of presentation of the media (e.g., media frame) represented by that particular query fingerprint. The presentation meter 108 may then periodically send bundles of these generated query fingerprints as query signature data to the computing system 130 for analysis.

As to watermarking, on the other hand, the media content as presented by the media presentation device 104 may be periodically or otherwise from time to time watermarked (e.g., steganographically encoded) with media-identifying information or with data that correlates with media-identifying information.

Audio, for instance, could be watermarked with such data by including a supplemental audio waveform (optimally outside of human hearing range) that carries a representation of the data. By way of example, if a codeword that identifies the media is a sequence of digits, each digit could be sequentially encoded into the audio by adding a unique tone combination having a predefined correlation with the digit. Further, synchronizing symbols could be encoded as respective tone combinations as well, to demarcate the presence of the watermark.

Using audio for example, as the media presentation proceeds, the presentation meter 108 may thus monitor the audio in search of such a watermark and, upon finding a watermark, may decode the watermark by evaluating the sequential tone combinations, as a basis to extract the media-identifying information. The presentation meter 108 may thus record this media-identifying information over time with timestamps indicating when the watermarked media was presented. And the presentation meter 108 may likewise periodically send bundles of this media-identifying information as query signature data to the computing system 130 for analysis.

In real-time or through post-processing as noted above, the computing system 130 may then compare this presentation-meter-reported query signature data with established reference signature data respectively representing known media content (e.g., known programs, advertisements, channels, etc.) And upon finding with sufficient certainty that the query signature data representing the media content presented at the panelist site 100 matches reference signature data representing specific known media content, the computing system 130 could conclude that the media presented at the panelist site 100 is that specific known media content.

The computing system 130 could then establish a media-presentation record as noted above, indicting the media presented at the panelist site 100. Further, the computing system 130 may correlate this record with associated panelist demographics and may use the resulting records as a basis to establish media-exposure data and audience ratings, and/or to facilitate one or more other operations.

In particular, whether through use of fingerprinting, watermarking, or other media-signature processes, the computing system 130 may thereby establish records indicating times when particular identified media content was presented at the panelist site 100 and correspondingly times when one or more panelists at the panelist site 100 were exposed to that media. Further, the computing system 130 may correlate this information with predetermined demographics regarding one or more panelists at the panelist site 100, to establish records of times when one or more panelists of the predetermined demographics were exposed to the identified media. The computing system 130 may further aggregate this type of information from multiple panelist sites as a basis to generate more comprehensive ratings statistics, which may help inform and control later placement of program or advertisement content and/or other actions.

Further in line with the discussion above, the streaming meter 110 may operate to monitor packet-data flow, such as streaming-media-related activity, on the LAN 112. In particular, the streaming meter 110 could be configured to monitor streaming-media activity on the LAN 112 by monitoring the LAN 112 to detect the occurrence of particular network events that relate to streaming-media sessions. To facilitate this, the streaming meter 110 could be configured to operate as a router, a packet-sniffer, and/or another device that would have a view of packet traffic traversing the LAN 112. For instance, the streaming meter 110 may be integrated with the router 120 or may be an additional router on the LAN 112. Alternatively, the second meter 110 may be a standalone packet-sniffer or the like.

When packets flow on the LAN 112, the streaming meter 110 may thus detect the flow of those packets. Further, the streaming meter 110 may read header data of the detected packets, to determine and record the source and destination IP addresses of the packets. And the streaming meter 110 may be able to read select payload data from the packets.

Based on this monitoring of the packets flowing on the LAN 112, the streaming meter 110 may be configured to detect the occurrence of particular network events related to streaming-media sessions and to report those detected network events to the computing system 130 along with associated timestamps indicating the times of occurrences of the network events. These network events could take various forms.

By way of example, the streaming meter 110 may monitor the bit rate of packet-data flow into the LAN 112, such as the bit rate of data flowing into the LAN from one or more IP addresses outside of the LAN 112, and the streaming meter 110 may record timestamps of when the streaming meter 110 detected certain bit rates of such packet-data flow into the LAN 112.

Further, the streaming meter 110 may filter this analysis to be with respect to packet-data communication with one or more streaming-media clients at the panelist site 100, such as for example with media player 106. Namely, the streaming meter 110 may consider header information in packets flowing on the LAN 112 as a basis to limit its analysis to packets to or from an IP address of such a streaming-media client, thus helping to focus on packet-data flow that may be more likely related to streaming-media communication.

Based at least on this monitoring of the bit rate of the packet-data flow, and the streaming meter 110 may detect and report when that packet-data flow into the LAN 112 has one or more characteristics that may be deemed a pattern of program streaming, such as a high enough bit rate over time that the flow is likely consistent with the typical flow of a streaming of program content. For instance, the streaming meter 110 may detect and report when the LAN 112 is receiving a packet-data flow that has a bit rate high enough to meet the “pattern of streaming” criteria discussed above, and based at least on that flow having that high bit rate, the streaming meter 110 may conclude that that flow has a pattern of program-content streaming.

Further, based at least on this monitoring of the bit rate of the packet-data flow into the LAN, the streaming meter 110 may detect and report when there is non-zero packet-data flow into the LAN 112 that does not have the one or more characteristics that may be deemed to be a pattern of program-content streaming. For instance, the streaming meter 110 may detect and report when the LAN 112 is receiving a packet-data flow that the streaming meter finds to be of a low enough bit rate over time, for example, not meeting the “pattern of streaming” criteria described above, thus indicating that the flow is likely not consistent with the typical flow of a streaming program content.

Still further, the streaming meter 110 may detect and report when transitions occur between these or other types of packet-data flow. For instance, the streaming meter 110 may detect and report when packet-data flow into the LAN 112 transitions from having one or more characteristics that may be deemed to be a pattern of program-content streaming (e.g., having a high enough bit rate over time to be consistent with typical streaming of program content) to not having the one or more characteristics that may be deemed to be pattern of program-content streaming (e.g., to having a non-zero but low enough bit rate over time that is not consistent with streaming of program content).

In addition, the streaming meter 110 may detect and report other associated information that may relate to transitions of packet-data flow into the LAN 112. For instance, the streaming meter 110 may detect and report when changes occur in the source IP address of packet data flowing into the LAN 112 and/or when changes occur in owner/DRM metadata carried by packet-data flowing into the LAN 112, among other possibilities. Further, the streaming meter 110 may detect and report other network activity, such as a rate or other extent to which back-and-forth packet-data communications occur between the panelist site 100 and a given external IP address, among other possibilities.

Based on this and/or other reporting from the streaming meter 110, the computing system 130 may determine when there was a pattern of program-content streaming at the panelist site 100 versus when there was a non-zero packet-data flow that did not rise to the level of a pattern of program-content streaming at the panelist site.

Optimally, as noted above, the computing system 130 may thereby infer when the panelist site 100 was potentially receiving streaming advertisement content. Namely, the computing system 130 may draw this inference, based at least on a determination of when the panelist site 100 was receiving a non-zero packet-data flow that did not rise to the level of a pattern of program-content streaming but might possibly be streaming of lower-bit-rate advertisement content. Alternatively, the streaming meter 110 may draw such inferences and report accordingly to the computing system 130.

In line with the discussion above, the computing system 130 may use this reporting and inference as a basis to control the computing system's searching through reference signature data for identifying media content presented at the panelist site 100.

As noted above, the computing system 130 may include or otherwise have access to various sets of reference signature data that the computing system 130 can search in an effort to find a match with presentation-meter-reported query signature data, so as to identify media content presented at the panelist site 100. As discussed above, these sets of reference data could include (i) the LMMS reference signature data 132, namely, linear broadcast reference signature data, (ii) the SMMS reference signature data 134, namely, streaming program reference signature data, and (iii) the AMMS reference signature data 136, namely, streaming advertisement reference signature data.

The timestamped query signature data that the computing system 130 receives from the presentation monitor 108 may define a sequence of time segments of query signature data corresponding with respective time segments of media presentation by the media-presentation device 104. The computing system 130 may therefore analyze each time segment of query signature data in an effort to find matching reference signature data and thereby to identify the media that was being presented at that time by the media-presentation device 104.

In line with the discussion above, as to each time segment of the query signature data, the computing system 130 may first search the LMMS reference signature data 134 in an effort to find a match that would establish that the media being presented at that time by the media-presentation device 104 was particular known linear broadcast content.

Further, as discussed above, if the computing system 130 does not find such a match, the computing system may then search the SMMS reference signature data 136 in an effort to find a match that would establish that the media being presented at that time by the media-presentation device 104 was particular known streaming-media content. But as noted above, the computing system 130 may be configured to perform this search of the SMMS reference signature data 136 only if the computing system 130 determines from streaming-meter reported data that, at the time of that media presentation, the panelist site 100 was receiving a packet-data flow that had a pattern of program-content streaming.

Per the present disclosure, if the computing system 130 determines from the streaming-meter-reported data or otherwise that, at the time of the media presentation represented by the query signature data, the panelist site 100 was receiving a packet-data flow that did not have a pattern of program-content streaming (e.g., that the panelist site 100 was receiving a packet-data flow that had a bit rate lower than that typical of media-program streaming), then the computing system 130 may optimally respond to at least that determination by performing advertisement matching. In particular, based at least in part on that determination, rather than simply defaulting to recording an “inconclusive” result as discussed above, the computing system 130 may then search the AMMS reference signature data 138 in an effort to find a match that would establish that the media being presented at that time by the media-presentation device 104 was a particular streaming advertisement.

If the computing system 130 thereby finds that the query signature matches certain AMMS reference signature data representing a known advertisement, the computing system 130 may then optimally establish a record that the media-presentation device 104 was presenting that advertisement at the time. Further, the computing system 130 may additionally take into account demographics and so forth as discussed above as a basis to establish media-exposure data and ratings statistics for various purposes. Whereas, if the computing system does not thereby find that the query signature matches any AMMS reference signature data, then the computing system may record an inconclusive result for that time segment.

As further noted above, the computing system 130 may also take into account one or more other factors as a basis to trigger this search of the AMMS reference signature data 138. The one or more other factors may also be based on network events reported by the streaming meter 108 and may help to infer that, at the time of the media presentation represented by the query signature data at issue, the panelist site 100 was receiving a streaming advertisement.

Various examples of these factors may relate to transitions in packet-data flow by detected and/or reported by the streaming meter 110.

For instance, the computing system 130 could effectively track over time when reported packet-data flow into the panelist site 100 had a pattern of program-content streaming versus when the packet-data flow into the panelist site 100 was non-zero but did not have a pattern of program-content streaming. And the computing system 130 could thereby detect that the packet-data flow had a pattern of program-content streaming except for one or more temporary break periods when the packet-data flow did not have a pattern of program-content streaming. Based at least on each such break period being just temporary, the computing system 130 may infer that the break period was a likely commercial break including one or more streaming advertisements.

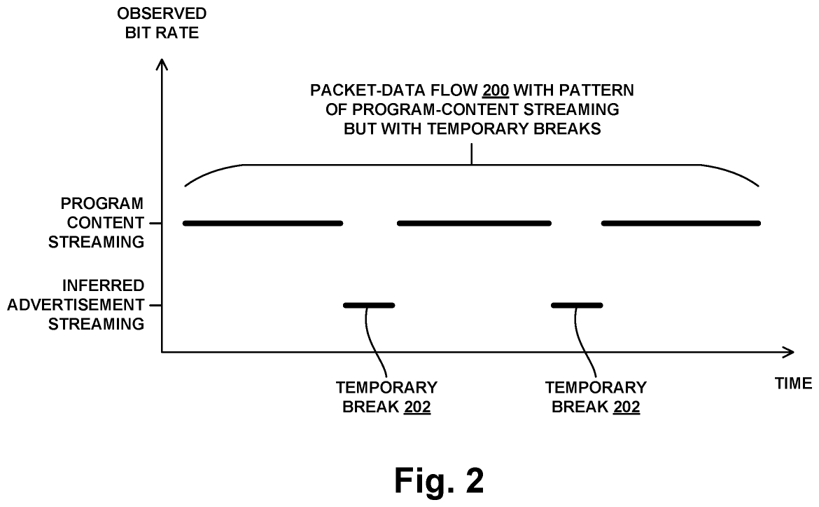

FIG. 2 conceptually illustrates this tracking and analysis by the computing system 130. Namely, FIG. 2 shows an example period 200 of observed packet-data flow deemed to have a high enough bit rate and/or one or more other characteristics as a pattern of program-content streaming, except for temporary break periods 202 of observed non-zero packet-data flow having a relatively low bit rate and/or otherwise lacked one or more characteristics of a pattern of program-content streaming.

Based on the temporary nature of one or more such break periods 202 during what is otherwise deemed to be packet-data flow having a pattern of program-content streaming, the computing system 130 may infer that each such break period 202 is a commercial break including one or more streaming advertisements. Further, the computing system 130 may also base this inference on how often the break periods 202 occurred and/or how long the break periods 202 were, possibly based on a finding that the frequency and/or length of the break periods is consistent with what is deemed typical frequency and/or length of commercial breaks.

In addition, the computing system 130 may take into account other related transition data. For instance, if reporting from the streaming meter 110 indicates that, when the flow transitioned to and from each one or more such temporary breaks 202 or otherwise, the packet-data flow into the panelist site 100 transitioned from one source IP address to another and/or transitioned from having one owner/DRM indication to another, the computing system 130 may consider that to be another factor to support the computing system's inference that a temporary break 202 is a commercial break, as the media player 106 may receive program content and advertisement content from different sources.

Further, the computing system 130 may take into account still other information as a basis to support its inference that a non-zero packet-data flow into the panelist site 100 is a streaming advertisement.

For instance, based on streaming-meter reporting the computing system 130 may determine that, during one or more of the temporary breaks 202, packet-data flow at the panelist site 100 had frequent-enough back-and-forth communication with a particular external IP address such that the packet-data flow may have been streaming-media-session signaling (e.g., for adaptive-bit-rate streaming) as opposed to mere browsing session or the like. The computing system 130 may then deem this to be a further basis for inferring that the panelist site 100 was receiving streaming advertisement content during such a temporary break 202.

Further, by reference to pre-provisioned panelist-site profile data (not shown) at the media-measurement platform 102, the computing system 130 may determine that the panelist site 100 subscribes to an ad-supported streaming media service (e.g., from a given OTT provider). And the computing system 130 may deem this to be another basis for inferring that the panelist site 100 was receiving streaming advertisement content during such a temporary break 202.

Optimally based on these and/or one or more other such factors, the computing system 130 may thereby infer that, at a time when the packet-data flow into the panelist site 100 did not have a pattern of program-content streaming, the packet-data flow may have been an streaming advertisement. Based at least on this inference, the computing system 130 may thus turn to search the AMMS reference-signature data 138 in an effort to find a match with query signature data for that time, as a basis to identify an advertisement that the media-presentation device 104 was presenting at that time.

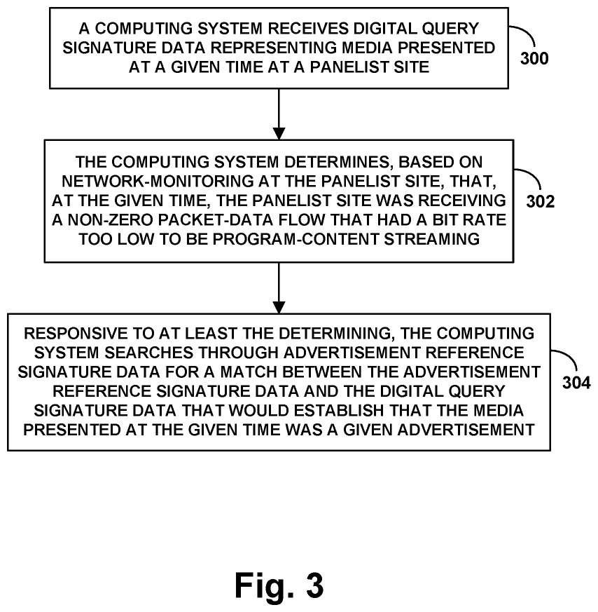

FIG. 3 is a flow chart illustrating a method that could be carried out in accordance with the present disclosure to help control advertisement-exposure monitoring, such as to control when a computing system should search for a match between query signature data and advertisement reference signature data.

As shown in FIG. 3, at block 300, the method includes a computing system receiving digital query signature data representing media presented at a given time at a panelist site. Further, at block 302, the method includes the computing system determining, based on network-monitoring at the panelist site, that, at the given time, the panelist site was receiving a non-zero packet-data flow that had a bit rate too low to be program-content streaming. And at block 304, the method includes, responsive to at least the determining, the computing system searching through advertisement reference signature data for a match, between the advertisement reference signature data and the digital query signature data, that would establish that the media presented at the given time was a given advertisement.

In line with the discussion above, this method could also involve the computing system additionally determining, based on the network monitoring at the panelist site, that the given time was during a temporary break from the panelist site receiving a packet-data flow that had a bit-rate high enough to be program-content streaming. And in that case, the act of searching through the advertisement reference signature data for the match could be further responsive to the additional determining.

Further, as discussed above, the method could also involve the computing system additionally determining, based on the network monitoring at the panelist site, (i) that the given time was during a temporary break from the panelist site receiving from a first source IP address a packet-data flow that had a bit rate high enough to be program-content streaming and (ii) that packet data received by the panelist site during the temporary break was from a second source IP address different than the first source IP address. And in that case as well, the act of searching through the advertisement reference signature data for the match could be further responsive to the additional determining.

Still further, as discussed above, the method could also involve the computing system additionally determining, based on the network monitoring at the panelist site, (i) that the given time was during a temporary break from the panelist site receiving a packet-data flow that had a bit rate high enough to be program-content streaming and that had first ownership metadata, and (ii) that packet data received by the panelist site during the temporary break had second ownership metadata different than the first ownership data. And in that case as well, the act of searching through the advertisement reference signature data for the match could be further responsive to the additional determining.

Yet further, as discussed above, the method could also involve the computing system additionally determining, based on the network monitoring at the panelist site, that, at the given time, packet-data flow between the panelist site an IP address included at least a predetermined threshold high rate of back-and-forth messaging (e.g., request and response messaging). And in that case as well, the act of searching through the advertisement reference signature data for the match could be further responsive to the additional determining.

As also discussed above, the method could further involve the computing system additionally determining that the panelist site subscribes to an advertisement-supported streaming media service. And in that case as well, the act of searching through the advertisement reference signature data for the match is further responsive to the additional determining.

In addition, as discussed above, the method could further involve, as a precursor to the determining and searching, the computing system finding that the digital query signature data does not match linear broadcast reference signature data.

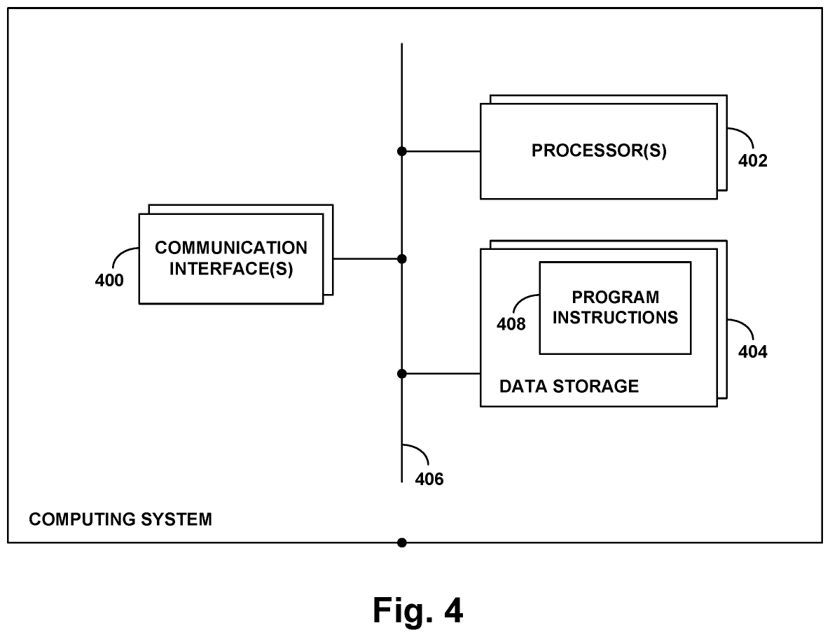

FIG. 4 is a simplified block diagram of a computing system that could be configured to carry out various operations such as those discussed herein. This computing system may represent one or more aspects of the computing system 130 discussed above.

As shown in FIG. 4, the example computing system could include at least one communication interface 400, at least one processor 402, and at least one non-transitory data storage 404, which could integrated together or communicatively linked together by a system bus, network, or one or more other connection mechanisms 406.

The at least one communication interface 400 could comprise one or more interfaces to facilitate wired and/or wireless communication with one or more other entities. Examples of such interfaces could include, without limitation, wired Ethernet interfaces and/or WiFi interfaces.

The at least one processor 402 could comprise one or more general purpose processing units (e.g., microprocessors) and/or one or more specialized processing units (e.g., digital signal processors, dedicated audio processors, dedicated watermark processors, etc.) Further, the at least one non-transitory data storage 404 could comprise one or more volatile and/or non-volatile storage components (e.g., flash, optical, magnetic, ROM, RAM, EPROM, EEPROM, etc.), which may be integrated in whole or in part with the at least one processor 402. As further shown, the at least one non-transitory data storage 404 could store program instructions 408, which may be executable by the at least one processor 402 to carry out various computing-system operations described herein.

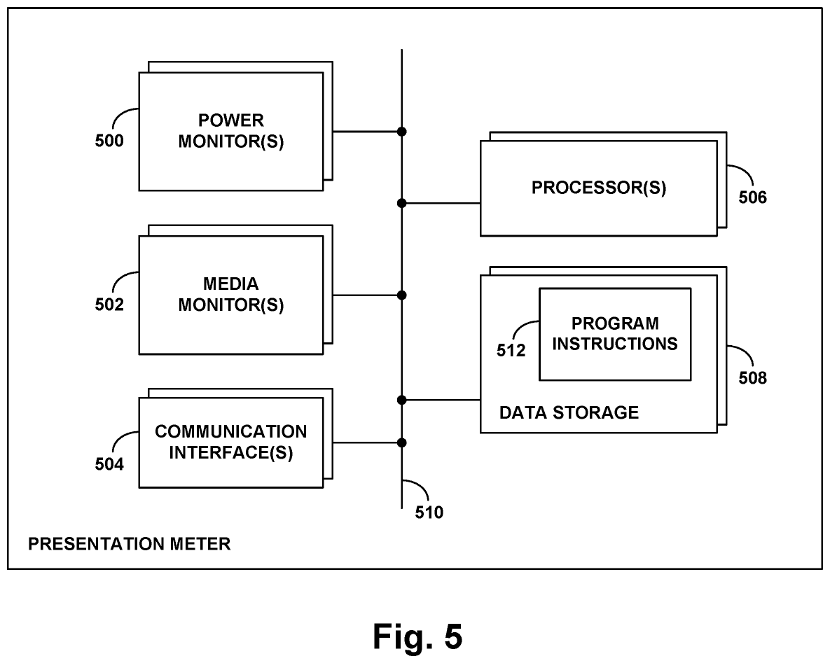

FIG. 5 is a simplified block diagram of a presentation meter. As noted above, such a presentation meter could be positioned and/or connected in a manner that enables the presentation meter to monitor media presented by a media-presentation device such as device 104, and that may also enable the presentation meter to monitor the on/off status of the media-presentation device.

As shown in FIG. 5, the example presentation meter includes at least one power monitor 500, at least one media monitor 502, at least one communication interface 504, at least one processor 506, and at least one non-transitory data storage 508, which could integrated together or communicatively linked together by a system bus, network, or one or more other connection mechanisms 510.

The at least one power monitor 500 could comprise a circuit for monitoring power flow to the media-presentation device, such as by tapping into a power-supply path to the media-presentation device and measuring current flow. The at least one power monitor 500 may thus operate to determine when the media-presentation device is powered on and when the media-presentation device is powered off.

The at least one media monitor 502 may comprise one or more microphones and/or cameras and associated processing circuitry or other logic configured to monitor media output from the media-presentation device and/or a circuit for monitoring media flow into the media-presentation device by tapping into a media-delivery path to the media-presentation device. The at least one media monitor 502 may thus operate to detect media presentation by the media-presentation device, which may further include obtaining media-signature data to facilitate identifying the presented media.

The at least one communication interface 504 may comprise one or more wired and/or wireless network interfaces, such as wired Ethernet interfaces and/or WiFi interfaces, to facilitate communication with other entities. For instance, the illustrated meter may use such a communication interface to report logged information to another meter and/or to a media-measurement server, among other possibilities.

The at least one processor 506 may comprise one or more general purpose processing units (e.g., microprocessors) and/or one or more specialized processing units (e.g., digital signal processors, dedicated audio processors, dedicated watermark processors, etc.) Further, the at least one non-transitory data storage 508 may comprise one or more volatile and/or non-volatile storage components (e.g., flash, optical, magnetic, ROM, RAM, EPROM, EEPROM, etc.), which may be integrated in whole or in part with the at least one processor 506. Still further, the at least one non-transitory data storage 508 may store program instructions 512, which may be executable by the at least one processor 506 to carry out various operations described herein.

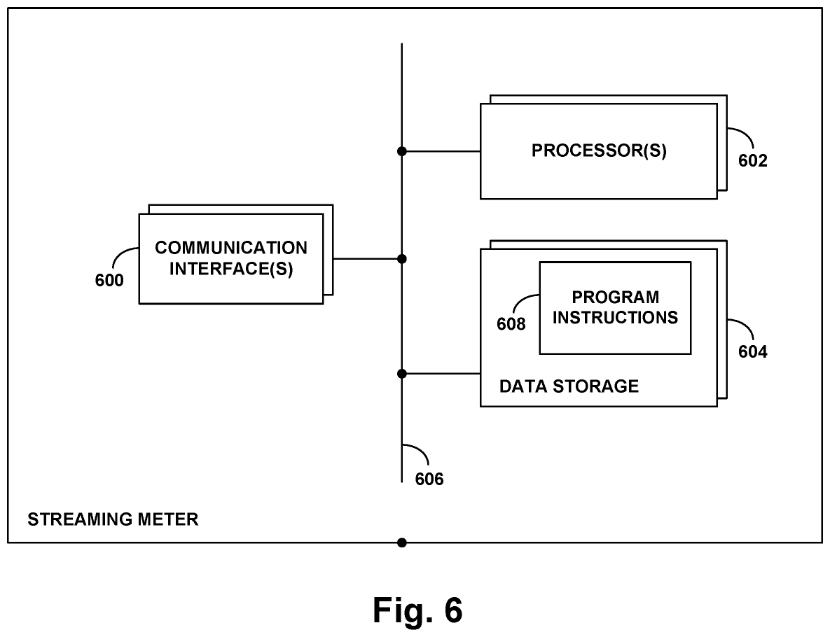

FIG. 6 is a simplified block diagram of a streaming meter. As noted above, such a streaming meter could be provided in a manner that enables the streaming meter to monitor packet flow on a LAN at a panelist site, so as to detect packet-data flow related to streaming media transmission.

As shown in FIG. 6, the example streaming meter includes at least one communication interface 600, at least one processor 602, and at least one non-transitory data storage 604, which could integrated together or communicatively linked together by a system bus, network, or one or more other connection mechanisms 606.

The at least one communication interface 600 may comprise one or more wired and/or wireless network interfaces, such as wired Ethernet interfaces and/or WiFi interfaces, to facilitate communication with other entities. For instance, the illustrated meter may use such a communication interface to engage in packet-sniffing on the LAN so as to detect on the LAN packet traffic related to streaming-media transmission. Further, the meter may use such a communication interface to report logged information to another meter and/or to a computing system, among other possibilities.

The at least one processor 602 may comprise one or more general purpose processing units (e.g., microprocessors) and/or one or more specialized processing units (e.g., digital signal processors, dedicated audio processors, dedicated watermark processors, etc.) Further, the at least one non-transitory data storage 604 may comprise one or more volatile and/or non-volatile storage components (e.g., flash, optical, magnetic, ROM, RAM, EPROM, EEPROM, etc.), which may be integrated in whole or in part with the at least one processor 602. Still further, the at least one non-transitory data storage 604 may store program instructions 608, which may be executable by the at least one processor 602 to carry out various operations described herein.

The present disclosure also contemplates at least one non-transitory computer readable medium that is encoded with, stores, or otherwise embodies program instructions executable by at least one processor to carry out various operations as described above.

Exemplary embodiments have been described above. Those skilled in the art will understand, however, that changes and modifications may be made to these embodiments without departing from the true scope and spirit of the invention.

1. A method for controlling advertisement-exposure monitoring, the method comprising:
receiving, by a computing system, digital query signature data representing media presented at a given time at a panelist site;
determining by the computing system, based on network-monitoring at the panelist site, that, at the given time, the panelist site was receiving a non-zero packet-data flow that had a bit rate too low to be program-content streaming; and
responsive to at least the determining, searching by the computing system through advertisement reference signature data for a match, between the advertisement reference signature data and the digital query signature data, that would establish that the media presented at the given time was a given advertisement.

2. The method of claim 1, further comprising additionally determining by the computing system, based on the network monitoring at the panelist site, that the given time was during a temporary break from the panelist site receiving a packet-data flow that had a bit rate high enough to be program-content streaming,
wherein the searching through the advertisement reference signature data for the match is further responsive to the additional determining.

3. The method of claim 1, further comprising additionally determining by the computing system, based on the network monitoring at the panelist site, (i) that the given time was during a temporary break from the panelist site receiving from a first source Internet Protocol (IP) address a packet-data flow that had a bit rate high enough to be program-content streaming and (ii) that packet data received by the panelist site during the temporary break was from a second source IP address different than the first source IP address, wherein the searching through the advertisement reference signature data for the match is further responsive to the additional determining.

4. The method of claim 1, further comprising additionally determining by the computing system, based on the network monitoring at the panelist site, (i) that the given time was during a temporary break from the panelist site receiving a packet-data flow that had a bit rate high enough to be program-content streaming and that had first ownership metadata, and (ii) that packet data received by the panelist site during the temporary break had second ownership metadata different than the first ownership metadata,
wherein the searching through the advertisement reference signature data for the match is further responsive to the additional determining.

5. The method of claim 1, further comprising additionally determining by the computing system, based on the network monitoring at the panelist site, that, at the given time, packet-data flow between the panelist site and an external Internet Protocol (IP) address included at least a predetermined threshold high rate of back-and-forth messaging,
wherein the searching through the advertisement reference signature data for the match is further responsive to the additional determining.

6. The method of claim 1, further comprising additionally determining by the computing system that the panelist site subscribes to an advertisement-supported streaming media service,
wherein the searching through the advertisement reference signature data for the match is further responsive to the additional determining.

7. The method of claim 1, further comprising, as a precursor to the determining and searching, finding by the computing system that the digital query signature data does not match linear broadcast reference signature data.

8. A computing system comprising:
at least one processor;
at least one non-transitory data storage;
program instructions stored in the at least one non-transitory data storage and executable by the at least one processor to carry out operations including:
receiving digital query signature data representing media presented at a given time at a panelist site,
determining, based on network-monitoring at the panelist site, that, at the given time, the panelist site was receiving a non-zero packet-data flow that had a bit rate too low to be program-content streaming; and
responsive to at least the determining, searching through advertisement reference signature data for a match, between the advertisement reference signature data and the digital query signature data, that would establish that the media presented at the given time was a given advertisement.

9. The computing system of claim 8, wherein the operations further include additionally determining, based on the network monitoring at the panelist site, that the given time was during a temporary break from the panelist site receiving a packet-data flow that had a bit rate high enough to be program-content streaming,
wherein the searching through the advertisement reference signature data for the match is further responsive to the additional determining.

10. The computing system of claim 8, wherein the operations further include additionally determining, based on the network monitoring at the panelist site, (i) that the given time was during a temporary break from the panelist site receiving from a first source Internet Protocol (IP) address a packet-data flow that had a bit rate high enough to be program-content streaming and (ii) that packet data received by the panelist site during the temporary break was from a second source IP address different than the first source IP address,
wherein the searching through the advertisement reference signature data for the match is further responsive to the additional determining.

11. The computing system of claim 8, wherein the operations further include additionally determining, based on the network monitoring at the panelist site, (i) that the given time was during a temporary break from the panelist site receiving a packet-data flow that had a bit rate high enough to be program-content streaming and that had first ownership metadata, and (ii) that packet data received by the panelist site during the temporary break had second ownership metadata different than the first ownership metadata,
wherein the searching through the advertisement reference signature data for the match is further responsive to the additional determining.

12. The computing system of claim 8, wherein the operations further include additionally determining, based on the network monitoring at the panelist site, that, at the given time, packet-data flow between the panelist site and an external Internet Protocol (IP) address included at least a predetermined threshold high rate of back-and-forth messaging,
wherein the searching through the advertisement reference signature data for the match is further responsive to the additional determining.

13. The computing system of claim 8, wherein the operations further include additionally determining that the panelist site subscribes to an advertisement-supported streaming media service,
wherein the searching through the advertisement reference signature data for the match is further responsive to the additional determining.

14. The computing system of claim 8, wherein the operations further include, as a precursor to the determining and searching, finding that the digital query signature data does not match linear broadcast reference signature data.

15. At least one non-transitory computer-readable medium having stored thereon instructions executable by at least one processor to carry out operations comprising:
receiving digital query signature data representing media presented at a given time at a panelist site;
determining, based on network-monitoring at the panelist site, that, at the given time, the panelist site was receiving a non-zero packet-data flow that had a bit rate too low to be program-content streaming; and
responsive to at least the determining, searching through advertisement reference signature data for a match, between the advertisement reference signature data and the digital query signature data, that would establish that the media presented at the given time was a given advertisement.

16. The at least one non-transitory computer-readable medium of claim 15, wherein the operations further comprise additionally determining, based on the network monitoring at the panelist site, that the given time was during a temporary break from the panelist site receiving a packet-data flow that had a bit rate high enough to be program-content streaming,
wherein the searching through the advertisement reference signature data for the match is further responsive to the additional determining.

17. The at least one non-transitory computer-readable medium of claim 15, wherein the operations further comprise additionally determining, based on the network monitoring at the panelist site, (i) that the given time was during a temporary break from the panelist site receiving from a first source Internet Protocol (IP) address a packet-data flow that had a bit rate high enough to be program-content streaming and (ii) that packet data received by the panelist site during the temporary break was from a second source IP address different than the first source IP address,
wherein the searching through the advertisement reference signature data for the match is further responsive to the additional determining.

18. The at least one non-transitory computer-readable medium of claim 15, wherein the operations further comprise additionally determining, based on the network monitoring at the panelist site, (i) that the given time was during a temporary break from the panelist site receiving a packet-data flow that had a bit rate high enough to be program-content streaming and that had first ownership metadata, and (ii) that packet data received by the panelist site during the temporary break had second ownership metadata different than the first ownership metadata,
wherein the searching through the advertisement reference signature data for the match is further responsive to the additional determining.

19. The at least one non-transitory computer-readable medium of claim 15, wherein the operations further comprise additionally determining, based on the network monitoring at the panelist site, that, at the given time, packet-data flow between the panelist site an external Internet Protocol (IP) address included at least a predetermined threshold high rate of back-and-forth messaging,
wherein the searching through the advertisement reference signature data for the match is further responsive to the additional determining.

20. The at least one non-transitory computer-readable medium of claim 15, wherein the operations further comprise additionally determining that the panelist site subscribes to an advertisement-supported streaming media service,
wherein the searching through the advertisement reference signature data for the match is further responsive to the additional determining.
